(19) United States
(12) Patent Application Publication
(10) Pub. No.: US 2011/0140594 A1
(43) Pub. Date: Jun. 16, 2011

(54) INORGANIC ELECTROLUMINESCENT DEVICE

(76) Inventor: Masashi Shirata, Kanagawa (JP)

(21) Appl. No.: 13/056,954

(22) PCT Filed: Jul. 29, 2009
(86) PCT No.: PCT/JP2009/063830

§ 371 Date: Jan. 31, 2011

(30) Foreign Application Priority Data
Jul. 31, 2008 (JP) 2008-198957

(51) Int. Cl. H01J 1/62

(52) U.S. Cl. 313/503

(57) ABSTRACT

An inorganic electroluminescent device is provided, the inorganic electroluminescent device including: a multilayer structure containing at least one pair of electrodes, and a light-emitting layer provided between the electrodes, the light-emitting layer contains at least one matrix material, at least one element forming a luminescent center, and Cu, wherein the matrix material is selected from the group consisting of II Group-XVI Group compounds, XII Group-XVI Group compounds, and mixed crystals thereof, and the light-emitting layer constitutes an inorganic phosphor layer having a composition gradient that Cu concentration in the host material varies by a factor of at least 10 in a thickness direction of the light-emitting layer.

### TECHNICAL FIELD

The present invention relates to an inorganic electroluminescent device and the like.

### BACKGROUND ART

Fluorescent materials are materials that emit light when energy, such as light, electricity, pressure, heat or electron beams, is applied thereto externally, and they are materials having been known for a long time. Of such materials, the fluorescent materials made up of inorganic materials have been used in Braun tubes, fluorescent lamps, electroluminescent (EL) devices and the like from their luminescence characteristics and stability. In recent years, research has been actively done on inorganic phosphors for uses as color conversion materials in LEDs and those for excitation by slow electron beams as in PDPs.

Electroluminescent (EL) devices using inorganic phosphor materials are roughly classified as alternating-current drive or direct-current drive according to their driving methods. Alternating-current-drive EL devices are divided into two types, a dispersed type that phosphor particles are dispersed in highly dielectric binder and a thin-film type that a thin film of phosphor is sandwiched between two dielectric layers. In direct-current-drive EL devices are included direct-current thin-film EL devices which each have a thin film of phosphor sandwiched between a transparent electrode and a metal electrode and are driven by low-voltage direct current.

Research on direct-current-drive inorganic EL devices was being conducted actively in the 1970-80s (Journal of Applied Physics, 52(9), 5797, 1981). The EL device of this type is a device structured to have a film of ZnSe:Mn which is formed on a GaAs substrate by use of MBE and sandwiched between the substrate and an Au electrode. The mechanism of luminescence by such a device consists in that, when a voltage of about 4V is applied to the device, electrons are injected from the electrode by the tunnel effect and excite Mn as luminescent center. However, such a device has low luminous efficiency (up to 0.05 lm/W) and low reproducibility, so even scientific research thereof, much less commercialization, has not been conducted since then.

Of late a new direct-current-drive inorganic EL device has been reported (WO 07/043,676 brochure). The new device uses as its luminescent material a ZnS system containing luminescent centers hitherto known, such as Cu or Mn, and has a structure that the ZnS system is sandwiched between an ITO electrode as a transparent electrode and an Ag electrode as a back electrode. Although the document has no description of the luminescence mechanism of the device, a conceivable mechanism is that Cu and Cl contained together in the system form a DA pair, and via the pair the injected electron and hole are recombined and emit light.

In addition, JP-A-2006-233147 discloses an electroluminescent device using the inorganic phosphor made up of zinc sulfide particles containing copper as an activator, at least either chlorine or bromine as a co-activator and at least one metal element belonging to Groups 6 to 10 in the second or third transition series.

Further, with the intention of adopting a direct-current drive, WO 07/139,032 brochure discloses the surface-emitting electroluminescent device into which a transparent metal oxide semiconductor/insulator is introduced.

In comparison with organic EL devices which emit light by a driving method similar to the above, direct-current-drive inorganic EL devices all constituents of which are inorganic materials has high durability and allows full use in various fields, such as illumination and display. LEDs driven likewise have a similarity in that all constituents of each are inorganic materials, but the light emission from LEDs is minimal in area, or equivalently, point light emission. Therefore, although LEDs produce lasers of high intensity per unit area, the lasers produced are short of absolute light quantity (luminous flux); as a result, LEDs are of limited application. On the other hand, inorganic EL devices give off surface light emission by nature, so they have an advantage in the possibility of delivering quantities of light flux.

In addition, JP-A-10-270733 describes the light-emitting device using a p-type compound semiconductor predominantly composed of elements belonging to Groups 11, 13 and 16 in the periodic table.

JP-A-2007-242603 discloses the direct-current-drive inorganic EL device provided with a p-type Cu-doped ZnS semiconductor layer and an n-type ZnS semiconductor layer having a donor level.

### SUMMARY OF INVENTION

However, the direct-current-drive inorganic EL devices disclosed in WO 07/043,676 and WO 07/139,037 are low in luminous efficiency. As to the EL device described in JP-A-2006-233147, the phosphor material used therein is a DA (donor-acceptor) pair luminescence type because it contains copper as its activator. Since inorganic phosphor materials of DA pair luminescence type can apply only to alternating-current-drive luminescent devices, there is a problem that the phosphor material of such a type is of limited application. On the other hand, JP-A-10-270733 gives no detailed description of phosphor materials usable for enhancing luminous efficiency. A further problem the devices disclosed in WO 07/139,037, JP-A-10-270733 and JP-A-2007-242603 have in common is that an interface is formed between definitely separated two layers in each of their structures and carriers accumulated on the interface induce interfacial degradation. So, remedies to this problem are sought.

The invention therefore aims to provide an inorganic EL device having sufficient luminous efficiency and durability.

As a result of our intensive studies, we have succeeded in achieving high-efficiency emission of light and high durability by the use of a light-emitting layer having a composition gradient that the Cu concentration in a matrix (i.e. a host material) varies by a factor of at least 10 in a thickness direction of the light-emitting layer.

The invention is attained by satisfying requirements as described below.
(1) An inorganic electroluminescent device, including:

a multilayer structure containing:

at least one pair of electrodes, and

a light-emitting layer provided between the electrodes, the light-emitting layer containing a matrix material, an element forming a luminescent center, and Cu,

wherein the matrix material is selected from the group consisting of II Group-XVI Group compounds, XII Group-XVI Group compounds, and mixed crystals thereof, and

the light-emitting layer constitutes an inorganic phosphor layer having a composition gradient that Cu concentration in the host material varies by a factor of at least 10 in a thickness direction of the light-emitting layer.
(2) The inorganic electroluminescent device as described in item (1) above,
wherein the element forming the luminescent center is selected from the group consisting of metal elements belonging to Groups 6 to 11 in second transition series and third transition series of the periodic table.
(3) The inorganic electroluminescent device as described in item (2) above,
wherein the light-emitting layer further contains at least one element selected from the group consisting of elements belonging to Groups 13 and 15 in the periodic table.

### BRIEF DESCRIPTION OF DRAWINGS

FIG. 1 is a diagram showing in outline the structure of a direct-current-drive inorganic EL device made in Example 1, wherein 1 denotes a glass substrate, 2 denotes a transparent electrode, 3 denotes a light-emitting layer (high Cu-concentration side), 4 denotes a light-emitting layer (low Cu-concentration side), and 5 denotes a back electrode; and

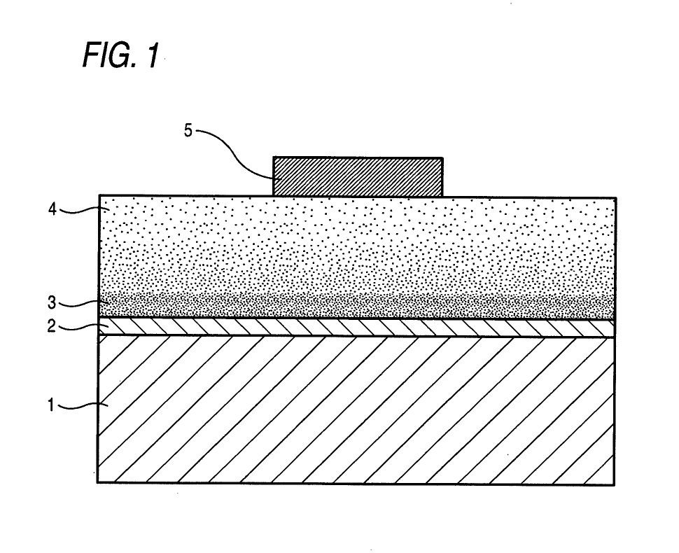

FIG. 2 is a graph showing the result of SIMS observation of the compositional distribution of Cu in the thickness direction of the light-emitting layer in the direct-current-drive inorganic EL device B made in Example 1.

### DESCRIPTION OF EMBODIMENTS

Detailed description of the invention is given below.

The present inorganic EL device is an inorganic EL device of a multilayer structure which has at least one pair of electrodes and a light-emitting layer formed in between, wherein the light-emitting layer has a matrix formed of at least one compound chosen between II Group-XVI Group compounds (namely, a compound which contains at least one element belonging to Group 2 in the periodic table and at least one element belonging to Group 16 in the periodic table) and XII Group-XVI Group compounds (namely, a compound which contains at least one element belonging to Group 12 in the periodic table and at least one element belonging to Group 16 in the periodic table), or a mixed crystal of both the compounds, and the light-emitting layer also contains at least one element forming luminescent centers, what's more the light-emitting layer further contains Cu and has a composition gradient that the Cu concentration in the matrix varies by a factor of at least 10 in a thickness direction of the light-emitting layer.

The expressions of “a II Group-XVI Group compound” and “a XII Group-XVI Group compound”, which are compounds usable as a material for the matrix of an inorganic phosphor material contained in the light-emitting layer of the present inorganic EL device, refer respectively to a compound that contains an element belonging to Group 2 in the periodic table and an element belonging to Group 16 in the periodic table and a compound that contains an element belonging to Group 12 in the periodic table and an element belonging to Group 16 in the periodic table, and they are wordings/expressions commonly used by persons having general knowledge in the technical field to which the invention belongs (persons skilled in the art).

As an example of a material for the matrix, one compound chosen between a II Group-XVI Group compound and a XII Group-XVI Group compound, such as ZnS, ZnSe, ZnTe, CdS, CdSe, CdTe, CaS, SrS, SrSe or BaS, or a mixed crystal thereof can be used. Suitable examples of a material for the matrix include ZnS, ZnSe, ZnSSe, SrS, CaS, SrSe and SrSSe. Of these compounds, ZnS, ZnSe and ZnSSe are preferred over the others.

The wording “a composition gradient in the thickness direction” refers to a continuously-varying composition observed in cross section of the device ranging from the vicinity of the interface between one electrode and a light-emitting layer to the vicinity of the interface between the other electrode and the light-emitting layer, and is characterized in that a difference made in composition ratio (especially Cu concentration in the matrix) between the side of high Cu concentrations and the side of low Cu concentrations is 10-fold or more. The difference made in composition ratio is preferably 100-fold or more, and far preferably 300-fold or more. On the side of low Cu concentrations, the Cu concentration may be made closer and closer to 0. In this case, the composition ratio of the high Cu concentration side to the low Cu concentration side is decided to approach to infinity.

By meeting such a requirement, it becomes easy in the region of high Cu concentrations to accomplish hole injection from an electrode and movement of holes. In the region of low Cu concentrations, on the other hand, it becomes easy to accomplish electron injection from an electrode and movement of electrons. Therefore, in the case of bearing in mind the direct-current drive of carrier injection type, electron-hole recombination occurs at luminescent centers evenly distributed in the light-emitting layer and high-efficiency luminescence is achieved.

The present inorganic EL device has a continuously-varying composition, and forms no definite interface between layers in contrast to the traditional devices as described in published documents. More specifically, the present inorganic EL device is characterized in that the composition varies continuously only in the depth direction (the concentration gradient of a constituent material varies continuously). The presence of a continuous concentration gradient can be ascertained by analyzing concentrations of a target element in the depth direction in the mixed region by means of e.g. a secondary ion mass spectroscope (SIMS) and drawing a concentration profile of the target element across the whole region. In other words, according to the analysis by SIMS, the concentration profile in the present inorganic EL device is not shaped like a rectangle, but is shaped like a line with continuously-varying gradients.

Although electron-hole recombination at the junction interface between a p-type semiconductor and an n-type semiconductor is generally known, not only the recombination at the interface but also electron-hole recombination at luminescent centers distributed in the interior of a light-emitting layer becomes important in the case of an inorganic EL device where the recombination at the luminescent centers contributes to luminescence. Accordingly, the composition gradient defined above is effective for high-efficiency luminescence.

When an interface is formed at the junction of p-type and n-type semiconductors, not only high-efficiency luminescence is not attained, but also degradation is caused by electrons and holes built up at the interface, so the formation of the interface adversely affects the durability. On the other hand, no definite junction interface is present in the present device, so the present device is free of such degradation and can have a long life.

The presence of a composition gradient in a depth direction can be ascertained by cutting out a cross section of the device with a diamond cutter and measuring composition ratios in the cross section with SEM (Scanning Electron Microscope) and EDX (Energy-Dispersive X-ray Fluorescence Spectrometer).

In forming the composition gradient as defined above, no restriction is placed on the method to be applied. In a case where the material for the matrix is e.g. ZnS, three methods are thought of, namely (1) a method of utilizing thermal anneal, (2) a method of utilizing control of a film formation rate and (3) a method of utilizing migration caused by application of an electric field.

More specifically, examples of the method (1) include a method of using a plurality of ZnS targets differing in Cu concentration and subjecting one target after another to electron-beam evaporation, and thereafter diffusing the Cu by thermal annealing, and a method of subjecting one of Cu₂S and ZnS in advance to electron-beam evaporation, then subjecting the other to electron-beam evaporation, and thereafter diffusing the Cu by thermal annealing.

The method (2) includes e.g. a method of forming the composition gradient by subjecting ZnS and Cu₂S to two-source electron-beam evaporation while controlling the output of each electron beam.

The method (3) include e.g. a method of subjecting Cu-doped ZnS to electron-beam evaporation, and then inducing Cu⁺ migration by application of an electric field between both electrodes, thereby giving the composition a gradient that the Cu concentration is high on the cathode side and low on the anode side.

Before application of an electric field in the method (3) in particular, the light-emitting layer contains Cu in an evenly distributed state, and the luminescence thereof is strong in itself to result in failure to achieve the intended luminescence. On the other hand, before formation of a composition gradient in the methods (1) and (2), an interface is present between layers differing in composition and constitutes one of degradation factors.

Examples of an element suitable for formation of luminescent centers, though the invention has no particular restriction on such an element, include not only Mn and rare-earth elements but also the metal elements belonging to Groups 6 to 11 in the second and third transition metal series in the periodic table (Mo, Tc, Ru, Rh, Pd, Ag, W, Re, Os, Ir, Pt, Au). Of these elements, the metal elements belonging to Groups 6 to 11 in the second and third transition metal series in the periodic table are preferred over the others. Among these metal elements, Ru, Pd, Os, Ir, Pt and Au are preferable to the others, and Os, Ir, Pt and Au are preferable by far. These metal elements may be contained alone, or as combinations of two or more thereof.

There is no particular restriction on the method of incorporating those elements for formation of luminescent centers into a material for the matrix (or the method of doping a material for the matrix with such elements). For instance, the elements may be incorporated in the form of metal salts at the time of grain formation through burning or, so long as fusion, sublimation or reaction thereof is possible under a burning condition, the elements may be incorporated in the form of compound crystals. In portions precipitated on and adsorbed to the crystal surface, other than those incorporated into crystals of a material for the matrix, those metals are preferably eliminated by etching, cleaning or the like. As the metal salt, any of compounds including oxides, sulfides, sulfates, oxalates, halides, nitrates and nitrides may be employed. Of these salts, oxides, sulfides and halides are preferred over the others. These salts may be used alone, or as combinations of two or more thereof.

The amount of the metal element used for doping is preferably from 1×10⁻⁷ to 1×10⁻¹ mole, far preferably from 1×10⁻⁵ to 1×10⁻² mole, per mole of material for the matrix.

Incorporation of at least one element chosen from the elements belonging to Group 13 or Group 15 in the periodic table is effective for enhancement of capabilities as inorganic phosphor materials.

More specifically, incorporation of at least one element chosen from the elements belonging to Group 13 and at least one element chosen from the elements belonging to Group 15 is preferred, incorporation of at least one element chosen from Ga, In or Ti as the element in Group 13 and at least one element chosen from N, P, Sb, As or Bi as the element in Group 15 is far preferred, and incorporation of Ga as the element in Group 13 and at least one element chosen from N, P, Sb or As as the element in Group 15 is particularly preferred.

In incorporating these elements into phosphor materials, it is advantageous to add a compound containing element(s) belonging to Group 13 and element(s) belonging to Group 15 (a XIII Group-XV Group compound).

The content of at least one element chosen from the elements belonging to Group 13 or Group 15 in the periodic table, though not particularly limited, is preferably from 1×10⁻⁷ mole to 1×10⁻² mole per mole of material for the matrix.

Next, a structure of an inorganic electroluminescent device according to the invention is described in detail.

While alternating-current-drive inorganic EL devices are generally driven through application of a voltage of 50-300 V at a frequency of 50-5,000 Hz, direct-current-drive inorganic EL devices feature the ability to be driven at a low voltage of 0.1-20 V. The present inorganic phosphor materials are useful for not only alternating-current-drive devices including alternating current dispersed inorganic EL devices and alternating current thin-film inorganic EL devices but also inorganic EL devices including direct-current-drive inorganic EL devices. Of all these devices, direct-current-drive inorganic EL devices are devices for which the present materials are especially useful.

The invention is described in more detail by taking as an example a direct-current-drive inorganic EL device to which the invention is applicable to particular advantage.

A direct-current-drive inorganic EL device includes one pair of electrodes and a light-emitting layer formed in between. Herein, it is preferable that at least one of the electrode pair is a transparent electrode (this electrode is also referred to as a transparent conductive film, and the other electrode is referred to as a back electrode). When the luminescent layer is too thick, attainment of the electric field intensity required for producing luminescence is attended with a rise in the voltage between both electrodes. For achieving low-voltage drive, it is therefore appropriate that the thickness of the luminescent layer be 50 μm or below, preferably 30 μm or below. On the other hand, when the luminescent layer is too thin, the electrodes formed on both sides of the luminescent layer tend to make a short circuit. For avoiding occurrence of a short circuit, it is appropriate that the thickness of the luminescent layer is 50 nm or more, preferably 100 nm or more.

### (Luminescent Layer)

In forming the luminescent layer, in addition to an electron-beam evaporation method, general methods for forming inorganic materials into films, such as physical evaporation methods including a resistance-heating evaporation method, sputtering, ionic plating and CVD (Chemical Vapor Deposition), can be adopted. Since the inorganic phosphor materials according to the invention are stable even at high temperatures and have a high melting temperature, the method suitable for use in the invention is an electron-beam evaporation method which is fit for evaporation of materials high in melting temperature, or a sputtering method in cases where evaporation sources can be made into targets. In performing electron-beam evaporation, when the vapor pressures of metals incorporated into phosphor materials are substantially different from the vapor pressure of a material for their matrix, it is also useful to adopt an evaporation method of utilizing a plurality of evaporation sources as independent evaporation sources. Moreover, in the sense of enhancing crystallinity, an MBE (Molecular Beam Epitaxy) method which gives consideration to lattice matching with a substrate is also used to advantage.

### (Transparent Conductive Film)

The surface resistivity of transparent conductive film used suitably in the invention is preferably 100Ω/□ or below, far preferably from 0.01 to 10Ω/□, particularly preferably from 0.01 to 1Ω/□.

The surface resistivity of transparent conductive film can be measured in conformance with the method described in JIS K6911.

The transparent conductive film is formed on a glass or plastic substrate, and it preferably contains tin oxide.

As the glass, though typical glass such as non-alkali glass or soda-lime glass can be used, glass having high heat resistance and high flatness is preferably used. As the plastic substrate, transparent film such as polyethylene terephthalate film, polyethylene naphthalate film or cellulose triacetate base can be used to advantage. On any of these substrates, a transparent conductive substance such as indium tin oxide (ITO), tin oxide or zinc oxide can be deposited and formed into film by evaporation, coating, printing or a like method.

In this case, it is favorable for enhancement of durability that tin oxide predominates in the surface layer of the transparent conductive film.

The deposition amount of a transparent conductive substance as a constituent of the transparent conductive film is preferably from 100% to 1% by mass, far preferably from 70% to 5% by mass, further preferably from 40% to 10% by mass, with respect to the transparent conductive film.

The method for preparing a transparent conductive film may be a gas phase method such as sputtering or vacuum evaporation. Alternatively, ITO or tin oxide in a pasty state may be formed into film by coating or screen printing and heated in its entirety, or it may be formed into film by heating with laser.

For the transparent conductive film used in the present EL devices, any of commonly used transparent electrode materials may be used. Examples of such a transparent electrode material include oxides, such as tin-doped tin oxide, antimony-doped tin oxide, zinc-doped tin oxide, fluorine-doped tin oxide and zinc oxide, a multilayer structure having a thin silver layer sandwiched between high-refraction layers, and conjugated polymers such as polyaniline and polypyrrole.

For further lowering the resistance, it is appropriate that current-carrying properties be improved by disposing reticulated or banded metallic fine wires, such as grid-shaped or comb-shaped metallic fine wires. Suitable examples of metal or alloy for the fine wires include copper, silver, aluminum and nickel. Such metallic fine wires may have an arbitrary size, but the preferred range of their size is from around 0.5 μm to 20 μm. The metallic fine wires are preferably disposed with 50-μm to 400-μm pitches, especially with 100-μm to 300-μm pitches. Since the light transmittance is reduced by disposing metallic fine wires, minimization of this reduction is important, and it is advantageous to ensure the light transmittance in a range of 80% to less than 100%.

The meshes of metallic fine wire may be stuck on transparent conductive film, or metal oxide or the like may be coated or deposited on metallic fine wires formed in advance on the film by mask evaporation or etching. Alternatively, the metallic fine wires may be formed on a thin film of metal oxide prepared in advance.

On the other hand, though different from the above in forming method, transparent conductive film suitable for the invention can be formed by lamination of metal oxide and a metallic thin film having an average thickness of 100 nm or below instead of metallic fine wires. As metals used for the metallic thin film, those having high corrosion resistance and excellent malleability and ductility, such as Au, In, Sn, Cu and Ni, are suitable, but usable metals are not limited to those metals in particular.

It is preferred that such multilayer film achieve high light transmittance, specifically light transmittance of 70% or higher, particularly preferably 80% or higher. The wavelength at which the light transmittance is defined is 550 nm.

The light transmittance can be measured by using an interference filter for extraction of 550-nm monochromatic light and integration actinography using a typical white light source, or with a spectrum measuring device.

### (Back Electrode)

Any of electrically conductive materials can be used for the back electrode provided on the side of which no light is taken out. According to the form of a device to be made, the temperatures in making processes and so on, the electrically conductive material for the back electrode can be chosen as appropriate from among metals, such as gold, silver, platinum, copper, iron and aluminum, or graphite. And it is important for the material chosen to have high thermal conductivity, preferably a thermal conductivity of 2.0 W/cm·deg or higher. Among them, silver or aluminum is preferable.

For ensuring a high degree of heat dissipation into the periphery of the EL device and high current-carrying capacity, the use of a metal sheet or a mesh of metal wires is also suitable.

### (Inorganic Phosphor Material)

The method applicable to formation of the present inorganic phosphor materials may be identical with the burning method (solid-phase method) widely used in the field.

Taking the case of zinc sulfide, fine-particle powder having particle diameters in the 10- to 50-nm range (referred to as crude powder) is prepared by the liquid-phase method and used as primary particles. Impurities called activators are mixed in the primary particles, and the resulting particles are placed in a crucible together with flux and subjected to first burning at a high temperature of 900° C. and 1,300° C. for a time period of 30 minutes to 10 hours, thereby obtaining particles. The particles as intermediate phosphor powder obtained by the first burning are washed repeatedly with ion exchange water to remove alkali metals or alkaline-earth metals and excesses of activator and co-activator. And subsequently the intermediate phosphor powder thus obtained is subjected to second burning. The second burning is performed by heating (annealing) at a lower temperature of 500° C. to 800° C. for a shorter time period of 30 minutes to 3 hours as compared to the first burning.

Although an inorganic phosphor material can be obtained by the preparation method as described above, when it is used in a direct-current inorganic EL device, the inorganic phosphor material is subjected to pressure molding and physical evaporation such as electron-beam evaporation, thereby the EL device is obtained.

### EXAMPLES

The invention will now be illustrated in further detail by reference to the following examples, but these examples should not be construed as limiting the scope of the invention in any way.

### (Inorganic Phosphor Material (Sample A))

ZnS, MnCl₂ and CuSO₄ were weighed out in amounts to provide 4×10⁻² mole of Mn and 6×10⁻³ mole of Cu per mole of Zn. These compounds were mixed for at least 20 minutes in a mortar, and then burned for 3 hours at 1,100° C. in a vacuum. After the burning, the burned matter was ground, washed and dried, thereby preparing an inorganic phosphor material ZnS: Mn,Cu (Sample A).

### (Inorganic EL Device A)

A transparent electrode 2 (first electrode) formed by sputtering ITO in a thickness of 200 nm was provided on a transparent glass substrate 1, and thereon the inorganic phosphor material of Sample A was formed into a 1,000 nm-thick film by means of EB evaporation apparatus. This film acted as a light-emitting layer 3. At the time of the film formation, the degree of vacuum in the evaporation chamber was set at 1×10⁻⁶ Torr and the substrate temperature was set at 200° C. After the film formation, for the purpose of enhancing crystallinity of the film, one-hour thermal anneal at 600° C. was further given to the film placed in the same chamber. Subsequently thereto, aluminum was evaporated by resistance heating evaporation, thereby forming a second electrode 5 (back electrode) on the light-emitting layer. Thus, a direct-current-drive inorganic EL element A was obtained.

### (Inorganic EL Device B)

A 5V direct-current power supply was connected to the inorganic EL device A so that the polarity of the aluminum electrode as the second electrode 5 was made positive and that of the transparent electrode as the first electrode 2 was made negative. By the application of such an electric field, Cu⁺ migrated toward the negative electrode and was able to create a composition gradient. The thus obtained device was referred to as an inorganic EL device B.

### (Inorganic EL Device C)

An inorganic EL device C was made in the same manner as the inorganic EL device B was made in, except that the application of electric field was carried out on a hot plate heated at 80° C.

### Example 1

Each of the inorganic EL devices A to C was cut on a cross section with a diamond cutter, and Zn/Cu ratios in the cross section were measured by SEM-EDX. Results obtained are shown in Table 1.

In addition, the luminescence intensity of each EL device was measured under conditions that the transparent electrode side was taken as positive electrode and the back electrode side as negative electrode and a direct-current voltage of 15 volts was applied between these electrodes. And the measured values are also shown in Table 1 as the relative intensities, with the device A being taken as 1.

TABLE 1

| | Cu concentration | Cu concentration | Ratio between | Relative intensity | |
|---|---|---|---|---|---|
| | on back | on transparent | Cu concentrations | of electro- | |
| | electrode side | electrode side | on two | luminescence | |
| | (mol/mol Zn) | (mol/mol Zn) | electrode sides | produced | Remarks |
| Inorganic | 5 × 10⁻³ | 5 × 10⁻³ | 1 | 1 | Comparative |
| EL device A | | | | | Example |
| Inorganic | 9 × 10⁻³ | 8 × 10⁻⁴ | 11 | 70 | Example |
| EL device B | | | | | |
| Inorganic | 5 × 10⁻² | 4 × 10⁻⁴ | 125 | 340 | Example |
| EL device C | | | | | |

Since the device A was made using the layer prepared by evaporation of ZnS, Cu and Mn as it was, no composition gradient was present therein and the Cu concentration is uniform inside the layer. On the other hand, the device B had the composition gradient induced by application of the electric field and the device C had the composition gradient induced by application of not only the electric field but also heat, so the ratio between Cu concentrations in both regions close to the electrodes in the device B was 11 and that in the device C was 125.

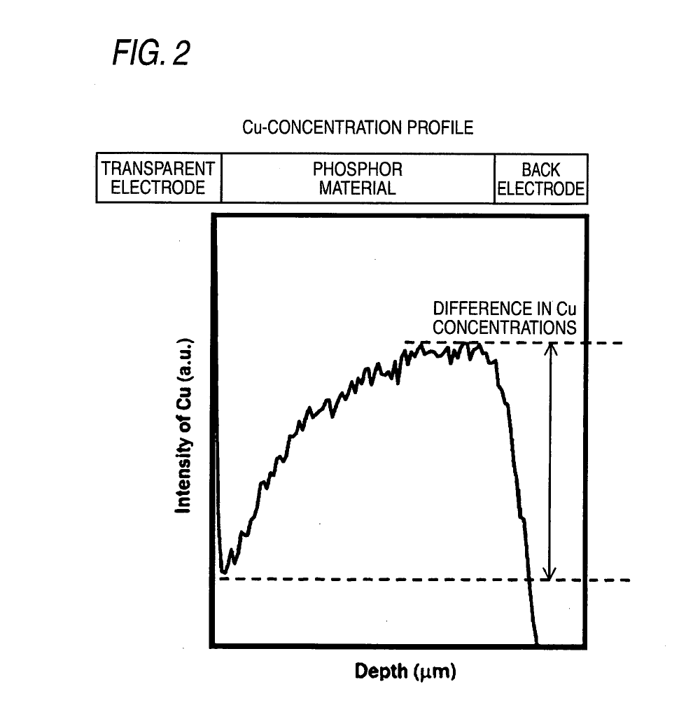

By way of example, the compositional distribution of Cu in the thickness direction of the light-emitting layer in the device B, which was analyzed by SIMS, is shown in FIG. 2. It can be seen from FIG. 2 that, as the Cu concentration profile varies continuously, the continuous composition gradient is present in the device B. Likewise, the presence of a continuous gradient in the device C was also recognized. In the relative intensity of electroluminescence also, the device B exhibited an increase as compared with the device A and the device C exhibited a substantial increase as compared with the device B, which indicates achievement of high-efficiency electroluminescence through composition gradient.

### Example 2

Inorganic EL devices were made in the same manner as in Example 1, except that ZnS as the matrix was changed to ZnS_{0.9}Se_{0.1}. In measurements of ratio between Cu concentrations on the two electrode sides and relative intensity of electroluminescence, these devices also achieved the same results as in Example 1, which indicates that effects from the composition gradient can be produced irrespective of the matrix used.

### Example 3

Inorganic EL devices were made in the same manner as in Example 1, except that IrCl₃ was used in place of MnCl₂. In measurements of ratio between Cu concentrations on the two electrode sides and relative intensity of electroluminescence, these devices also achieved the same results as in Example 1, which indicates that effects from the composition gradient can be produced irrespective of what element forms luminescent centers.

### Example 4

Inorganic EL devices were made in the same manner as in Example 1, except that HAuCl₄ was used in place of MnCl₂. In measurements of ratio between Cu concentrations on the two electrode sides and relative intensity of electroluminescence, these devices also achieved the same results as in Example 1, which indicates that effects from the composition gradient can be produced irrespective of what element forms luminescent centers.

### Example 5

Inorganic EL devices were made in the same manner as in Example 3, except that GaAs was added in an amount of 2×10⁻⁴ mole per mole of Zn. In measurements of ratio between Cu concentrations on the two electrode sides and relative intensity of electroluminescence, these devices also achieved the same results as in Example 3, which indicates that effects from the composition gradient can be produced irrespective of what element forms luminescent centers.

### INDUSTRIAL APPLICABILITY

Inorganic EL devices according to the invention have excellent luminous efficiency and deliver long-life high luminance.

1. An inorganic electroluminescent device, comprising:
a multilayer structure containing at least one pair of electrodes, and
a light-emitting layer provided between the electrodes, the light-emitting layer containing at least one matrix material, at least one element forming a luminescent center, and Cu,
wherein the matrix material is selected from the group consisting of II Group-XVI Group compounds, XII Group-XVI Group compounds, and mixed crystals thereof, and the light-emitting layer constitutes an inorganic phosphor layer having a composition gradient that Cu concentration in the matrix material varies by a factor of at least 10 in a thickness direction of the light-emitting layer.

2. The inorganic electroluminescent device according to claim 1,
wherein the element forming the luminescent center is selected from the group consisting of metal elements belonging to Groups 6 to 11 in second transition series and third transition series of the periodic table.

3. The inorganic electroluminescent device according to claim 2,
wherein the light-emitting layer further contains at least one element selected from the group consisting of elements belonging to Groups 13 and 15 in the periodic table.
